(19) United States
(12) Patent Application Publication
(10) Pub. No.: US 2022/0197915 A1
(43) Pub. Date: Jun. 23, 2022

(54) DYNAMIC ENTITY VISUALIZATION OF SEARCH RESULTS

(71) Applicant: 4IQ, Inc., Los Altos, CA (US)

(72) Inventors: RAGHAVENDRA BHAGAVATHA, San Jose, CA (US); PULLESWARARAO NAGA VANDANAPU, Redwood City, CA (US); ERIN BROWN, Hove (GB)

(21) Appl. No.: 17/128,651

(22) Filed: Dec. 21, 2020

(51) Int. Cl. G06F 16/2457; G06F 16/9038; G06F 16/901

(52) U.S. Cl. CPC G06F 16/24578; G06F 16/9024; G06F 16/9038

(57) ABSTRACT

A combined search and graph interface is provided for facilitating investigative searches. In an embodiment, a set search results for a first search is concurrently displayed with a graph that represents the first search. User input is received that selects a first search result from the set of search results for the first search. In response, a node is added to the graph that represents the first search result and one or more child nodes that each correspond to a named entity extracted from a data source that corresponds to the first search result are added below the node in the graph. In another embodiment, a second search is initiated in response to receiving user input that selects a node from the graph. The graph and a second set of search results generated by the second search are concurrently displayed in the combined search and graph interface.

### FIELD OF THE INVENTION

The present invention relates to software and, more specifically, to an application that generates a combined search and graph interface for facilitating investigative searches.

### BACKGROUND

Investigators perform investigative searches for various entities such as email addresses, social profiles, search engine results, dark web forums, and so on. Each investigative search is typically conducted as a series of searches, where the results of a prior search in the series may be used as the starting point of a subsequent search in the series. There are no limits to how deep or wide the series of searches may become. Consequently, the sheer amount of data obtained during the searches, and the relationships among such data, can be overwhelming to visualize, track and manage.

In one approach, investigative searches are performed by manually adding nodes to a graph that representing points of interest related to the investigation. As an investigative search expands, graphs generated that represent the search often become extremely large, making the graphs difficult to manage and decipher.

In another approach, investigative searches are performed by searching through various data sources and manually recording navigational actions as a user branches through different data sources, such as webpages and documents. However, using this type of searching approach lacks visibility and makes it difficult for a user to interact with the search, such as by backtracking and branching from one data source to another.

Techniques are desired to facilitate investigative searches in a scalable, efficient manner that allows investigators to visualize and interact with a search.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 illustrates a combined search and graph interface that may be generated by a mobile or web application, according to an embodiment;

FIG. 2 illustrates the combined search and graph interface of FIG. 1 after a search result is selected from the search results, according to an embodiment;

FIG. 3 illustrates a close up view of the graph from FIG. 2, according to an embodiment;

FIG. 4 illustrates a display of search results that result from initiating a search from a node of the graph shown in FIG. 3, according to an embodiment;

FIG. 5 illustrates a combined search and graph interface rendered in response to a user selecting one of the search results shown in FIG. 4, according to an embodiment;

FIG. 6 illustrates a display of search results with named entities, according to an embodiment;

FIG. 7 is a block diagram of a computer system upon which the techniques described herein may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

A combined search and graph interface is provided for facilitating investigative searches. As mentioned above, each investigative search may involve a series of distinct searches, where a search result obtained by one search is used as the starting point for a subsequent search. For the purpose of explanation, the first search performed during an investigative search is referred to herein as the level-1 search. Any search initiated from any result of the level-1 search is referred to as a level-2 search. Similarly, any search initiated from any result of a level-2 search is referred to herein as a level-3 search.

When a user initiates a level-1 search for a target, the combined search and graph interface concurrently displays a set search results for the level-1 search and a graph that includes a first node corresponding to the “target” of the level-1 search. The target of a search may be, for example, the keywords used to perform the search.

When a user selects a search result from level-1 search results, a second node is added to the graph that represents the selected level-1 search result. To represent a direct relationship between the target of the level-1 search and the selected level-1 search result, the second node is displayed as directly connected to the first node in the graph.

In the event that the selected level-1 search result corresponds to a data source that is associated with one or more named entities, one or more child nodes that correspond to the one or more named entities are added to the graph. For example, assume that the selected level-1 search result is a user profile that includes four named entities: two email addresses, a user_id, and an IP address. In this example, four child nodes would be added below that second node, one for each of the four named entities extracted from the selected user profile.

As a user continues searching and selecting search results, nodes that correspond to the user's search result selections are automatically added to the graph. A search can be initiated from any node that exists in the graph. For example, the user may select that node that corresponds to any of the four named entities that were extracted from the selected level-1 search result. When the user selects the node that represents a particular named entity from the selected level-1 search result, a level-2 search can be initiated based on the named entity that corresponds to the selected node. In response to initiating a level-2 search from the selected named entity node, the graph and a set of level-2 search results generated by the search are concurrently displayed in the combined search and graph interface.

The combined graph and search interface discussed herein provides a simultaneous interleaving of search functionality and graph building. Using the combined interface, a user can interact with search results using the graph and/or the search interface while simultaneously recording the results of their investigation in the graph. Using techniques discussed herein, by tracking specific actions used to conduct an investigative search, the combined interface and associated functionality simplifies an investigation process by automatically recording navigational structure of a search into an easy-to-navigate and digestible graph.

### Combined Search and Graph Interface

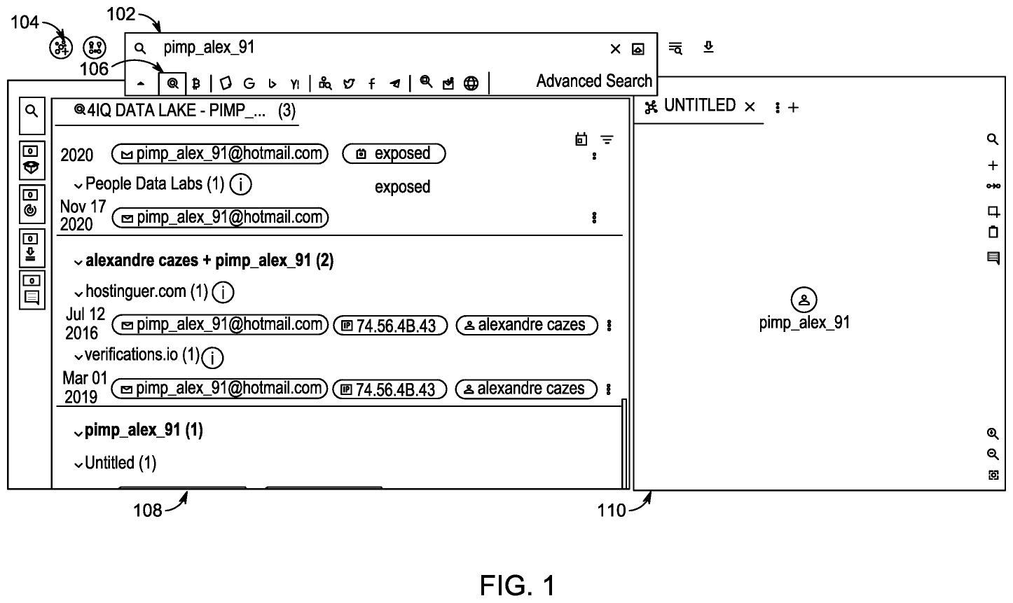

Referring to FIG. 1, it illustrates a combined search and graph interface that may be generated by a mobile or web application. In the combined search and graph interface illustrated in FIG. 1, a user is presented with a search bar 102 shown at the top of FIG. 1, search results display region 108 shown on the left of FIG. 1, and a graph display region 110 shown on the right of FIG. 1. FIG. 1 also shows a data source selection 106, shown below the search bar and a record button 104 shown to the left of search bar 102. When a user is preparing to perform a search, data source selection 106 can be used to select a data source for executing the search on.

When the record button 104 is enabled by a user and a level-1 search is initiated for a target, the search results display region 108 is populated with results of the search and a node is automatically added to the graph that represents the target of the search. In the present example, “pimp_alex_91” is the target of the current search. The search results display region 108 shows search results corresponding to the search target “pimp_alex_91”. The graph display region 110 shows a graph that includes a single node corresponding to “pimp_alex_91”.

Each search result of the search results display region 108 is displayed with a date and one or more name entities. Each named entity shown for a search result is extracted from a data source that corresponds to the particular search result. For example, the search result titled “hostinguer.com” is associated with the named entities including “Name: alexander cazes”, “Ip: 74.56.48.43”, “Email: pimp_alex_91@hotmail.com” which are extracted from the “hostinguer.com” data source. Details regarding how named entities are extracted from data sources are further discussed herein.

### Selecting a Level-1 Search Result

In one embodiment, in response to performing a search, the graph display region 110 is not automatically populated with nodes for each of the search results. Doing so would cause the graph to become crowded and difficult to decipher. Further, a search may produce hundreds of search results, where only a few of those search results are of interest to the searcher. Thus, instead of automatically populating the graph with nodes for all search results, the user can select to explicitly “add to graph” a search result. Doing so will not only cause a node for that search result item to be added to the graph, but it will also cause a set of child nodes to be added to the graph, where the child nodes correspond to named entities extracted for the selected search result item.

As a user selects different search results from search results display region 108, the selections made by the user are automatically recorded and visualized in the graph display region 110. Specifically, when the user clicks on a particular search result in the search results display region 108, a node that represents the selected search result is created in the graph display region 110. When the user selects a named entity or hyperlink, further search is performed based on the selected entity or link and the search results display region 108 is repopulated with the results of the further search. As the user selects more search results as the search activities progress, additional nodes are added to the graph display region 110 along with connectors that indicate relationships between nodes.

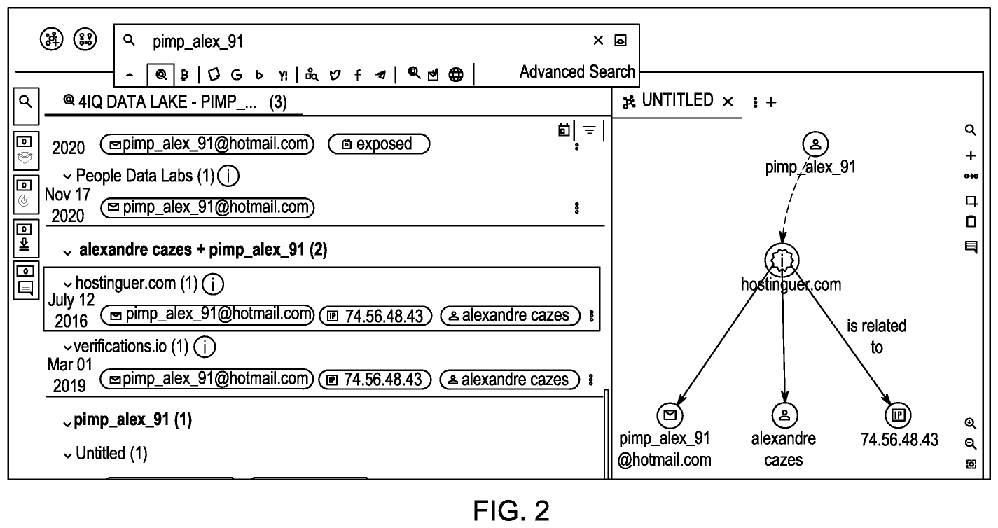

For example, upon inspecting the search results for the level-1 search illustrated in FIG. 1, the user may select a level-1 search result as the basis for a level-2 search. For the purpose of explanation, it shall be assumed that the user selects the level-1 search result titled “hostinguer.com”. In response, a node is added to the graph display region 110 to represent the data source “hostinguer.com”, as illustrated in FIG. 2. In addition, nodes are added to the graph display region 110 to represent the named entities (e.g. “Ip: 74.56.48.43”) that were extracted from “hostinguer.com”.

### The Record Button

The record button 104 can be used as a mechanism for controlling when user selections from the search results display region 108 are automatically added as nodes in the graph. In one embodiment, when the record button 104 is enabled, selections made from search results display region 108 are automatically added as nodes in the graph display region 110. In one embodiment, when the record button 104 is disabled, selections made from search results display region 108 are not automatically recorded as nodes in the graph display region 110. In one embodiment, even if the record button 104 is disabled, a user can manually add nodes to the graph display region 110 by selecting a search result from the search results display region 108 and commanding the interface to explicitly “add to graph” the selected search result.

Referring again to FIG. 2, it illustrates the combined search and graph interface of FIG. 1 when a search result is selected from the search results. In the present example, the data source “hostinguer.com” is selected from the search results by a user. In response to the selection, a node corresponding to the data source “hostinguer.com” is added to the graph. Additionally, because the search result “hostinguer.com” represents a data source and is associated with the named entities including “Name: alexander cazes”, “Ip: 74.56.48.43”, “Email: pimp_alex_91@hotmail.com”, a set of child nodes that correspond to the named entities are added to the graph.

As shown in FIG. 2, dotted lines between nodes in the graph may indicate indirect relationships (e.g. “produced the search result”) and the presence of a search result node. For example, the dotted line between the node “pimp_alex_91” and the node “hostinguer.com” indicates that the node “hostinguer.com” is associated with a search result, and that the search result was found based on a search made using the target associated with the parent node, “pimp_alex_91”. On the other hand, solid lines between nodes in the graph may indicate direct relationships (e.g. “contains the named entity”). Thus, the solid line between the node “hostinguer.com” and the node “hotmail.com” indicates that the node“hotmail.com” is a named entity extracted from the data source node “hostinguer.com”.

Initiating a Search from a Node

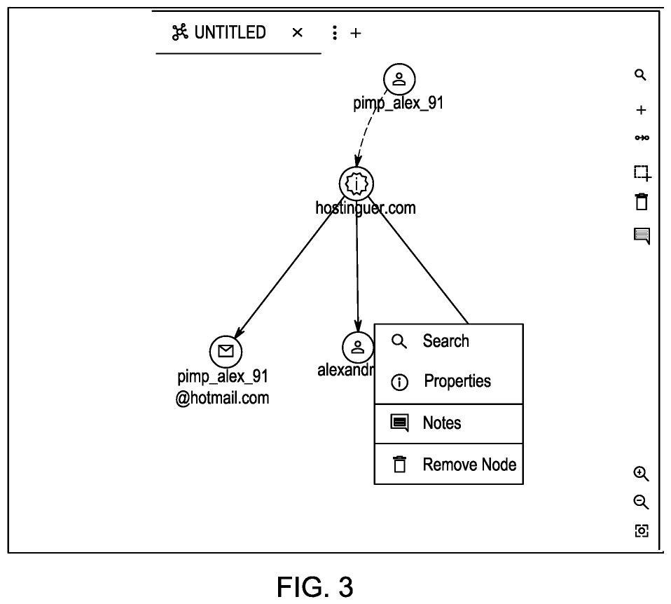

In addition to initiating a search using the search bar or by selecting a hyperlink or entity from the search results as discussed with respect to FIG. 1 and FIG. 2, a level-(N+1) search can be initiated from any level-N node in a graph to continue an investigation of an entity. Referring to FIG. 3, it illustrates a close up view of the graph from FIG. 2. In the present example, the “Search” function is selected for the node “Alexandre cazes”. As explained above, the “Alexandre cazes” node was a named entity node from the level-1 search result “hostinguer.com”. When the ‘Search’ function is selected for a node, a level-2 search is initiated and the respective level-2 search results are displayed in the search results display area. Additionally, based on the type of entity that is selected for a search, a corresponding data source may automatically selected as a target data source for the level-2 search. A list of data sources may be curated by an administrator for each different type of entity. For example, if a Username entity type is selected for a search, the ‘Social Profiles’ data source is selected as the target data source for executing the search.

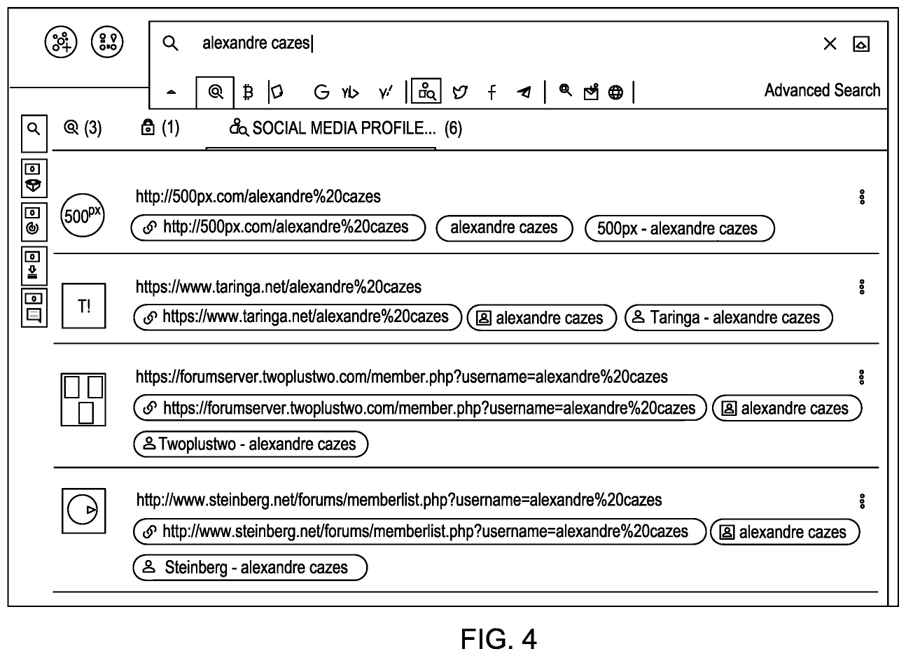

Referring to FIG. 4, it illustrates a display of the level-2 search results that result from initiating a search from a node of the graph shown in FIG. 3. In the present example, FIG. 4 displays search results that result from the selection of the “Search” function for the node “Alexandre cazes” as shown in FIG. 3. The search results show results of the search target “Alexandre cazes” in the target data source “Social Profiles”.

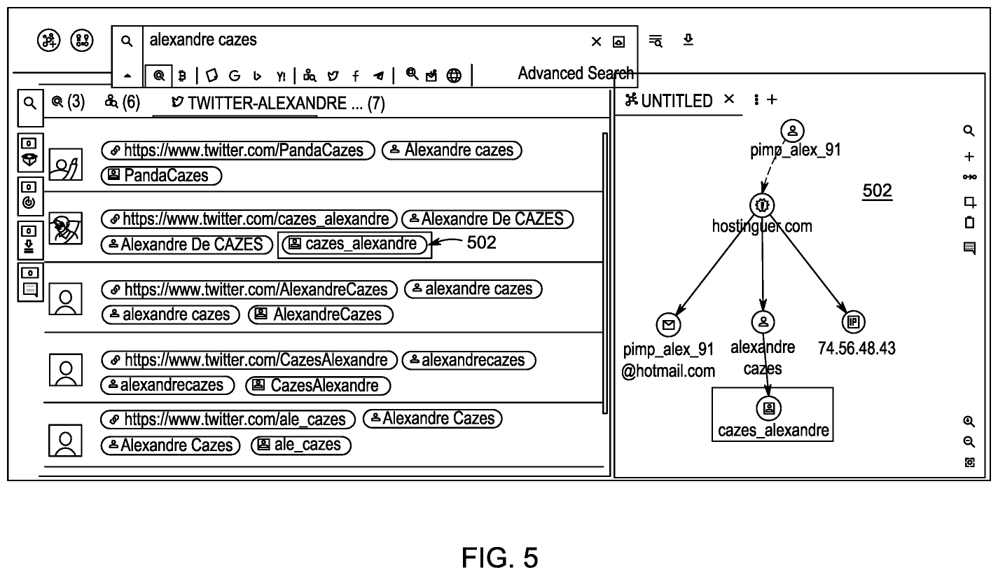

Referring to FIG. 5, it illustrates a combined search and graph interface rendered in response to a user selecting one of the search results shown in FIG. 4. In the present example, the named entity “CazesAlexandre” 502 is selected by a user from the search results. In response, a node that represents the named entity “CazesAlexandre” is automatically added to the graph. The graph shows the node “CazesAlexandre” directly connected to the node “Alexandre cazes”.

### Entity Extraction and Ranking

When a search is initiated and search results are retrieved from a data source, the resulting content of the search results is scanned for entities such as email addresses, usernames, names, phone numbers, etc. The identified entities are displayed prominently in association with the data sources of the entities in the search results.

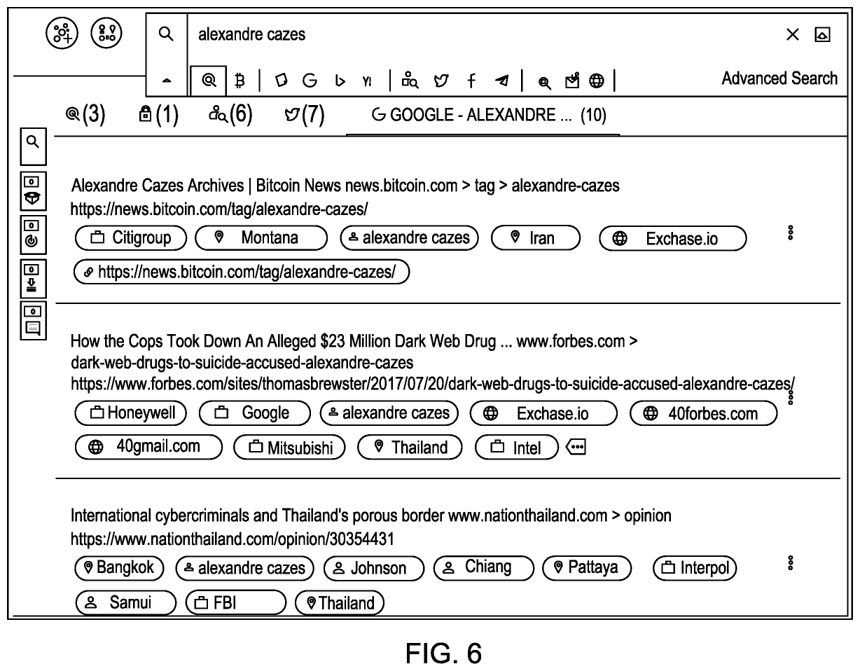

Referring to FIG. 6, it illustrates a display of search results with named entities. In the present example, the search result “Untitled” that is represented by the hyperlink “http://pastebin.com/XJqmKp4k” is displayed with the named entities: ‘Marcos’, ‘Aberto Kuselman’, ‘Madison’, ‘Lucy Parsons’, ‘Colin Jenkins’, ‘Barack Obama’, ‘Keith Alexander’, ‘Trump’, ‘andl’. The named entities are extracted from the “Bins” data source using machine learning based techniques.

In some embodiments, in addition to extracting named entities from various data sources, named entities are ranked based on the relevance to the entity being investigated. Relevance scores may be generated that indicate a metric of relevance between a search target and named entity. In one embodiment, entities with higher relevance scores are displayed at the top of the search results to draw more attention. This minimizes the time taken by users to look for these entities in the search results.

### Benefits

The combined graph and search interface discussed herein provides a simultaneous interleaving of search functionality and graph building. Using the combined interface, a user can interact with search results using the graph and/or the search interface while simultaneously recording the results of their investigation in the graph.

Previous techniques directed to recording investigations in a graph suffer from building a large graph that includes unnecessary nodes and data points. Such large graphs have marginal utility and become increasingly difficult to manage at some point during a search. Using techniques discussed herein, by tracking specific actions used to conduct an investigative search, the combined interface and associated functionality simplifies an investigation process by automatically recording navigational structure of a search into a graph.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

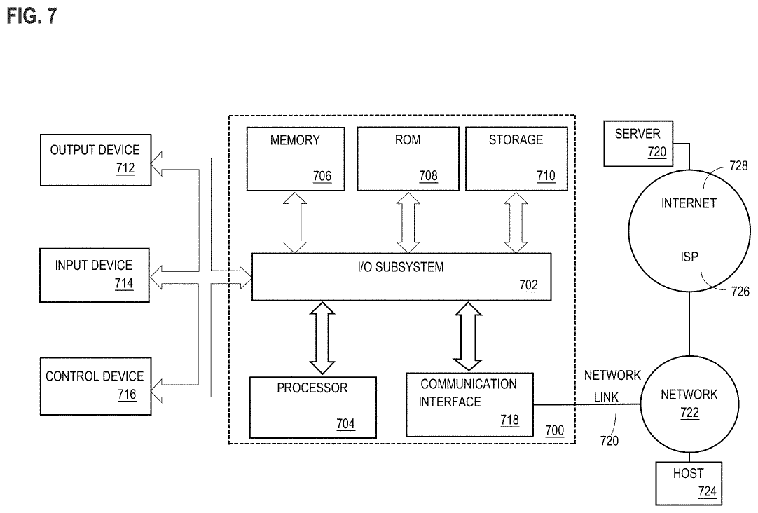

For example, FIG. 7 is a block diagram that illustrates a computer system 700 upon which an embodiment of the invention may be implemented. Computer system 700 includes a bus 702 or other communication mechanism for communicating information, and a hardware processor 704 coupled with bus 702 for processing information. Hardware processor 704 may be, for example, a general purpose microprocessor.

Computer system 700 also includes a main memory 706, such as a random access memory (RAM) or other dynamic storage device, coupled to bus 702 for storing information and instructions to be executed by processor 704. Main memory 706 also may be used for storing temporary variables or other intermediate information during execution of instructions to be executed by processor 704. Such instructions, when stored in non-transitory storage media accessible to processor 704, render computer system 700 into a special-purpose machine that is customized to perform the operations specified in the instructions.

Computer system 700 further includes a read only memory (ROM) 708 or other static storage device coupled to bus 702 for storing static information and instructions for processor 704. A storage device 710, such as a magnetic disk, optical disk, or solid-state drive is provided and coupled to bus 702 for storing information and instructions.

Computer system 700 may be coupled via bus 702 to a display 712, such as a cathode ray tube (CRT), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane.

Computer system 700 may implement the techniques described herein using customized hard-wired logic, one or more ASICs or FPGAs, firmware and/or program logic which in combination with the computer system causes or programs computer system 700 to be a special-purpose machine. According to one embodiment, the techniques herein are performed by computer system 700 in response to processor 704 executing one or more sequences of one or more instructions contained in main memory 706. Such instructions may be read into main memory 706 from another storage medium, such as storage device 710. Execution of the sequences of instructions contained in main memory 706 causes processor 704 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 710. Volatile media includes dynamic memory, such as main memory 706. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 702. Transmission media can also take the form of acoustic or light waves, such as those generated during radio-wave and infra-red data communications.

Various forms of media may be involved in carrying one or more sequences of one or more instructions to processor 704 for execution. For example, the instructions may initially be carried on a magnetic disk or solid-state drive of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card, cable modem, satellite modem, or a modem to provide a data communication connection to a corresponding type of telephone line. As another example, communication interface 718 may be a local area network (LAN) card to provide a data communication connection to a compatible LAN. Wireless links may also be implemented. In any such implementation, communication interface 718 sends and receives electrical, electromagnetic or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the world wide packet data communication network now commonly referred to as the “Internet” 728. Local network 722 and Internet 728 both use electrical, electromagnetic or optical signals that carry digital data streams. The signals through the various networks and the signals on network link 720 and through communication interface 718, which carry the digital data to and from computer system 700, are example forms of transmission media.

Computer system 700 can send messages and receive data, including program code, through the network(s), network link 720 and communication interface 718. In the Internet example, a server 730 might transmit a requested code for an application program through Internet 728, ISP 726, local network 722 and communication interface 718.

The received code may be executed by processor 704 as it is received, and/or stored in storage device 710, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

1. A method comprising:
displaying a combined search and graph interface that concurrently displays:
a search results display region that includes a set of search results for a first search, and
a separate graph display region that includes a graph that represents the first search;
while the search results display region displays the set of search results for the first search and the graph display region does not display any nodes for the search results of the first search, receiving user input that selects, from the search results display region, a first search result from the set of search results for the first search; and
in response to the user input that selects the first search result from the search results display region, adding a node to the graph within the graph display region that represents the first search result and adding one or more child nodes below the node in the graph, wherein the one or more child nodes each correspond to a named entity extracted from a data source that corresponds to the first search result.

2. The method of claim 1, wherein each child node of the one or more child nodes corresponds to an entity type.

3. The method of claim 1, wherein displaying the set of search results comprises displaying at least one search result in association with one or more named entities extracted from a data source that corresponds to the at least one search result.

4. The method of claim 3, wherein the one or more named entities are displayed in an order that corresponds to a relevance ranking of the one or more named entities.

5. The method of claim 1, further comprising:
receiving user input that selects a second search result from the set of search results for the first search;
in response to the user input that selects the second search result, adding a node to the graph that represents the second search result.

6. (canceled)

7. The method of claim 1, further comprising:
receiving user input that selects a particular child node of the one or more child nodes;
in response to receiving user input that selects the particular child node, initiating a second search;
concurrently displaying the graph and a second set of search results generated by the second search.

8. The method of claim 7, further comprising:
receiving user input that selects a particular search result from the set of search results for the second search;
in response to the user input that selects the particular search result, adding a node to the graph that represents the particular search result, wherein the node that represents the particular search result is directly connected to the particular child node in the graph.

9. A method comprising:
displaying a combined search and graph interface that concurrently displays:
a search results display region that includes a first set of search results for a first search, and
a separate graph display region that includes a graph that represents the first search;
wherein the graph includes a node that represents a particular search result of the first set of search results for the first search and one or more child nodes that represent named entities extracted from a data source that corresponds to the particular search result;
receiving user input that selects, from the graph display region, a child node of the one or more child nodes that corresponds to a particular named entity extracted from the data source;
in response to receiving user input that selects the child node from the graph display region:
initiating a second search that uses search criteria to narrow the first set of search results of the first search based on the particular named entity,
without updating the graph within the graph display region with results of the second search, updating the search results display region to indicate a second set of search results generated by the second search, and
concurrently displaying, within the combined search and graph interface, the graph within the graph display region and the second set of search results generated by the second search within the search results display region.

10. The method of claim 9, wherein each child node of the one or more child nodes corresponds to an entity type.

11. The method of claim 9, wherein displaying the first set of search results comprises displaying at least one search result in association with one or more named entities extracted from a data source that corresponds to the at least one search result.

12. The method of claim 11, wherein the one or more named entities are displayed in an order that corresponds to a relevance ranking of the one or more named entities.

13. The method of claim 9, further comprising:
automatically selecting a target data source for the second search based on an entity type of the selected child node.

14. The method of claim 9, further comprising:
receiving user input that selects a search result from the second set of search results for the second search;
in response to the user input that selects the search result from the second set of search results, adding a node to the graph that represents the search result from the second set of search results, wherein the node that represents the search result from the second set of search results is directly connected to the child node in the graph.

15. The method of claim 7, further comprising:
automatically selecting a target data source for the second search based on an entity type of the particular child node.

16. The method of claim 1, further comprising:
receiving user input that selects a record button that is configured to control when user selections of search results from the search results display region are automatically added as nodes of the graph in the graph display region;
wherein before receiving the user input that selects the record button, the record button is disabled;
while the record button is disabled, in response to receiving user input that selects the first search result from the search results display region:
initiating a second search that uses search criteria to narrow the set of search results of the first search based on the selected first search result, and
without updating the graph within the graph display region with results of the second search, updating the search results display region to indicate a second set of search results generated by the second search;
in response to the user input that selects the record button, enabling the record button;
while the record button is enabled, in response to the user input that selects the first search result from the search results display region, automatically adding the node to the graph within the graph display region that represents the first search result and adding the one or more child nodes below the node in the graph.
